(19) United States
(12) Patent Application Publication
(10) Pub. No.: US 2023/0086009 A1
(43) Pub. Date: Mar. 23, 2023

(54) SYSTEM AND TECHNIQUES TO NORMALIZE OBJECTS IN SPATIAL IMAGING OF SPACES

(71) Applicant: LATCH SYSTEMS, INC., New York, NY (US)

(72) Inventors: Luke Andrew SCHOENFELDER, New York, NY (US); Saayuj DHANAK, New York, NY (US); Dhruva RAJENDRA, New York, NY (US); Ivan Almaral SOLE, New York, NY (US); Preeti PILLAI, New York, NY (US)

(21) Appl. No.: 17/951,516

(22) Filed: Sep. 23, 2022

Related U.S. Application Data
(60) Provisional application No. 63/247,518, filed on Sep. 23, 2021.

(51) Int. Cl. G06T 19/00; G06T 17/00; G06V 40/10; G06V 20/52; G06V 10/764

(52) U.S. Cl. CPC G06T 19/00; G06T 17/00; G06V 40/10; G06V 20/52; G06V 10/764

(57) ABSTRACT

Embodiments are generally directed to generating and providing normalized representation in a three-dimensional (3D) model.

### CROSS-REFERENCE TO RELATED APPLICATIONS

This application claims priority to U.S. Provisional patent application Ser. No. 63/247,518, filed on Sep. 23, 2021 and entitled “SYSTEM AND TECHNIQUES TO PERFORM SPATIAL IMAGING.” The contents of the aforementioned application are hereby incorporated by reference in their entirety.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example of a system 100 in accordance with embodiments.

FIG. 2 illustrates an example of a processing flow 200 in accordance with embodiments.

FIG. 3 illustrates an example of a 3D model 302 of a space generated in accordance with embodiments discussed herein.

FIG. 4 illustrates an example of a 3D model 302 of a space with people in accordance with embodiments discussed herein.

FIG. 5 illustrates an example of a 3D model 302 of a space with representations of the people in accordance with embodiments discussed herein.

FIG. 6 illustrates an example of a view 600 in accordance with embodiments.

FIG. 7 illustrates a computer architecture 700 in accordance with embodiments.

FIG. 8 illustrates a communications architecture 800 in accordance with embodiments.

FIG. 9 illustrates an aspect of the subject matter in accordance with embodiments.

### DETAILED DESCRIPTION

Systems and techniques discussed herein provide security for spaces in a real-time non-discriminatory manner. Physical spaces, such as spaces used for residential, office, retail, or industrial purposes, require a certain level of security. The people inside, society, law enforcement personnel, and/or government entities expect a certain level of security for these spaces, such that people can conduct their daily activities without experiencing violence, threats of violence, or other undesirable situations.

For embodiments discussed herein, Security means “retrospective security,” which involves the investigation of a security incident after an occurrence, and “preventative security,” which deploys tools and processes to prevent security incidents from occurring in the first place. A tool that is used for both retrospective and preventative security in most public and managed spaces is video security. Video security uses capturing devices (e.g., cameras), recorders, processors, and cloud storage systems, which record, stream, and analyze visual information. However, video security is inherently visual and can often come at the expense of privacy and partiality of the people it is deployed to protect.

For example, when monitoring video feeds to prevent a security incident, a user of video security, such as a guard, can view the physical attributes and likeness of people in the building (referred to in this document as Personally Identifiable Physical Information or PIPI). This is also almost always at the expense of the person's consent and knowledge. Further, during an investigation of a security incident, a guard or law enforcement professional will be exposed to the PIPI of many users who are irrelevant to the investigation. The exposure of this PIPI without the consent of the individuals could be a breach of their privacy. Further, inadvertent exposure to irrelevant PIPI for video security professionals and law enforcement may hinder the partiality of the investigation and expose those individuals to bias and liability. Ultimately, video security should not unnecessarily expose the PIPI of individuals and create unintentional or intentional discrimination.

Embodiments discussed herein are directed to solving these problems. Moreover, embodiments may include one or more systems configured to provide video security for spaces in a non-discriminatory manner while protecting the privacy of the people being monitored. For example, systems discussed herein may include generating three-dimensional model(s) of the spaces to be monitored using image data captured by one or more cameras. The system may also include capturing and processing real-time from one or more cameras, which may be the same or different from the cameras used to capture the 3D model(s).

The systems may process the real-time image data, including applying one or more object detection algorithms to detect objects and people. Once the people are detected, the systems may process the data so that a person watching the video will know that the object is a person but will not be exposed to PIPI. Specifically, the systems may generate a representation of the person that removes the PIPI. The representation may be inserted into the 3D model of the space and presented to a viewer on a display of a device, e.g., a remote computer, a local computer, a mobile device, etc. Thus, a user may be able to monitor spaces to ensure they are secure and view videos capturing security incidents without being exposed to PIPI unless necessary to prevent the security incident and identify the person committing the security incident. These and other details will become more apparent in the following description.

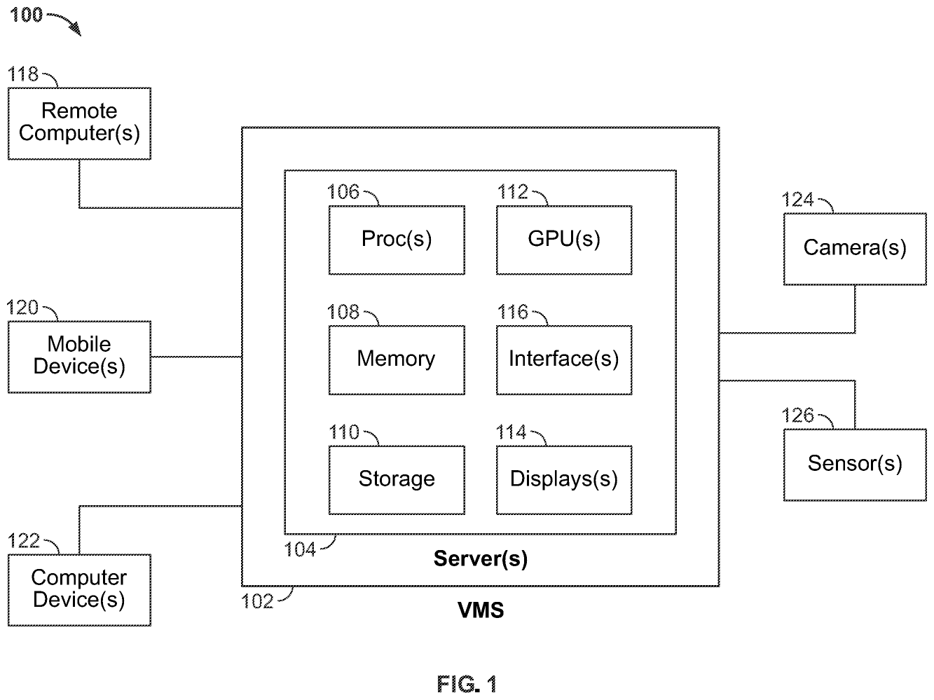

FIG. 1 illustrates an example of a system 100 configured to perform operations discussed herein. System 100 may be implemented to monitor the security of one or more spaces. For example, the system 100 may be implemented in an apartment building, an office building, a condominium, a house, etc. Other examples may include public places such as an airport, a stadium or arena, and so forth. As will be discussed in more detail, the system 100 may include one or more additional systems including compute components that is configured to capture image data, perform object detection analyses, provide representations of people in 3D model environments.

The illustrated example of the system 100 includes a video management system 102 configured to communicate with camera(s) 124, sensor(s) 126, remote computing device(s) 118, and computer device(s) 122. The video management system 102 may include hardware and software to provide video management and monitoring services. For example, the video management system 102 may include server(s) 104, which may be local or cloud-based servers, configured to process data from the camera(s) 124 and sensor(s) 126 to provide the security features discussed herein.

The server(s) 104 may include components configured to process data and provide the features. For example, the server(s) 104 may include at least processor(s) 106, memory 108, storage 110, graphic processing unit(s) 112, display(s) 114, and interface(s) 116. The processor(s) 106 may include any type of processor such as multi-core processors configured to process data and be coupled with memory 108 to store instructions for processing. The memory 108 may include volatile and non-volatile memory configured to temporarily and/or permanently store instructions and data to perform the operations discussed herein.

In embodiments, the graphic processing unit(s) 112 may be specialized electronic circuits designed to rapidly manipulate and alter memory to accelerate the creation of images in a frame buffer intended for output to a display device, e.g., display(s) 114. The graphic processing unit(s) 112 may manipulate computer graphics and image processing. The graphic processing unit(s) 112 may include highly parallel structures making them more efficient than general-purpose central processing units (CPUs), e.g., processor(s) 106, for algorithms that process large blocks of data in parallel. In the server(s) 104, a GPU can be present on a video card or embedded on the motherboard. In some instances, the graphic processing unit(s) 112 may be implemented on the processor(s) 106, e.g., embedded on the die. In embodiments, at least a portion of the processing discussed herein including object detection analytics, generating representations of objects, performing normalization operations, and so forth may be performed by the GPUs 112.

In embodiments, the server(s) 104 may include and/or be coupled with one or more display(s) 114 configured to display information and data. The display(s) 114 may be any type of display including a flat panel display, a liquid crystal display, a light-emitting diode (LED) display, a plasma display, and so forth. In embodiments, graphic processing unit(s) 112 may generate data and graphics that may be displayed on the display(s) 114. In one example, the data and graphics may be displayed in a graphical user interface (GUI). Embodiments are not limited in this manner.

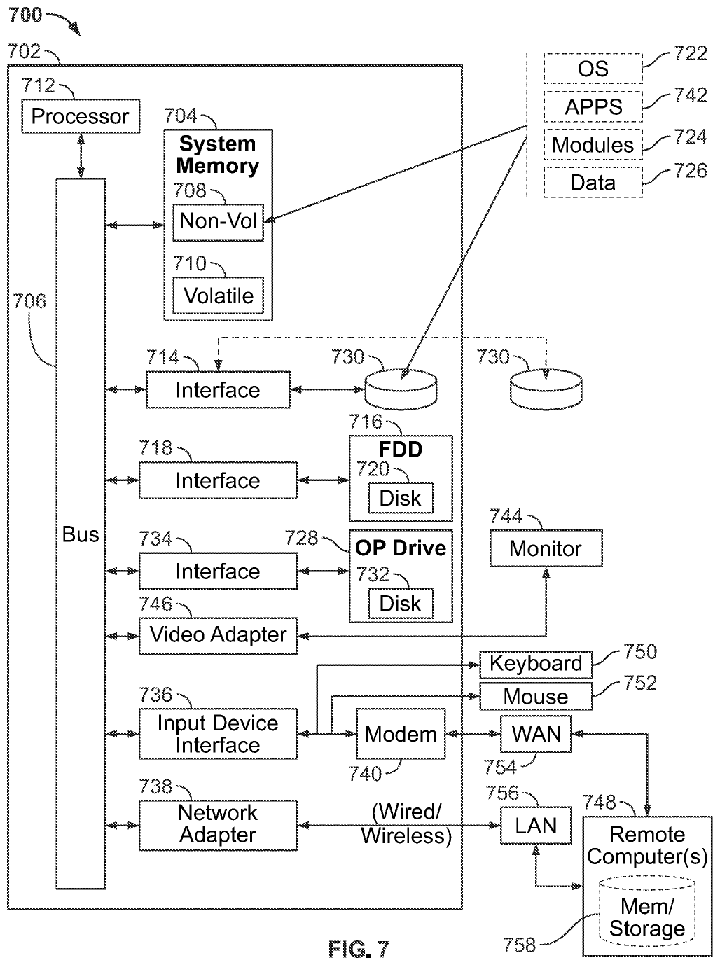

The server(s) 104 may also include one or more interface(s) 116. The interface(s) 116 may include serial interfaces including universal serial bus (USB) interface, a touch-sensitive interface, networking interfaces (wired and wireless), an array of communications transceivers (e.g., near field communication (NFC) transceivers, Bluetooth Low Energy (BLE) transceivers, and/or RF/WiFi transceivers), an ethernet interface(s), or any other type interface, such those discussed in computer architecture 700 of FIG. 7. These interfaces 116 are configured to couple the one or more servers 104 to one or more other devices of the system 100 include the camera(s) 124, the sensor(s) 126, the remote computer 118, the mobile device(s) 120, the computing device(s) 122, etc.

In the system 100 includes one or more camera(s) 124 configured to capture image data. In embodiments, the camera(s) 124 may include image sensors configured to capture image data in two-dimensional (2D) or 3D. For example, the camera(s) 124 may include 2D image sensor(s) and/or 3D image sensor(s). Examples of camera(s) 124 include a 2D camera, a 3D camera, a 360-degree camera, a time-of-flight camera, a structured light camera, a stereo camera, and so forth. In some instances, the camera(s) 124 may be implemented in a mobile device. In embodiments, the camera(s) 124 may be configured to detect image data and provide the image data to the video management system 102, which may reconstruct the image data to generate a 3D reproduction or model of a space.

In embodiments, the system 100 may also include one more sensor(s) 126 to implement the embodiments discussed. The one or more sensor(s) 126 may include depth sensors, range sensor(s), range camera(s), etc., configured to capture multi-point distance information across a field of view (FoV) to generate range image data. The sensor(s) 126 may be configured with the video management system 102 to apply one or more techniques to generate the range image data. For example, the sensor(s) 126 may be configured to operate according to techniques such as stereo triangulation, sheet of light triangulation, structured light, time-of-flight, interferometry, coded aperture, etc. In some instances, the sensor(s) 126 may be implemented in the camera(s) 124; and embodiments are not limited in this manner. The camera(s) 124 the sensor(s) 126 may provide data, such as image data and/or range image data to the video management system 102. The video management system 102 may process the data, including combining data to generate a 3D reproduction of a space. In embodiments, the camera(s) 124 and sensor(s) 126 may be located in spaces that are typically monitored by a security personal, such as public spaces of apartment buildings, businesses, offices, and other public areas.

In embodiments, the system 100 also includes one or more devices that may interface with the video management system 102 and are configured to interact with the video management system 102 and display data to users. For example, the system 100 may include one or more remote computing device(s) 118, mobile device(s) 120, and computer device(s) 122 configured to communicate and interface with the video management system 102.

In embodiments, the remote computing device(s) 118 may be any type of computing device, such as a computer, a server, a workstation, a monitoring station, etc., and is located remotely from the video management system 102 and/or the server(s) 104. For example, the video management system 102 may be implemented in an apartment building, and the remote computing device(s) 118 may be located in a remote monitoring location in a different building. In embodiments, one or more remote computing device(s) 118 may be cloud-based computing devices.

The mobile device(s) 120 may be any type of mobile device, such as a personal digital assistant (PDA), a cellular telephone device, a smartphone, a tablet computer, etc. The mobile device(s) 120 may be configured such that it can be carried by a user such as security personnel. Embodiments are not limited manner.

The computer device(s) 122 may be any type of computing device including a computer, a server, a workstation, a monitoring station, etc., and may be at the same location as the video management system 102. For example, the computer device(s) 122 may be located at a security desk or room in the same building as the video management system 102.

In embodiments, the video management system 102 is coupled with the remote computing device(s) 118, the mobile device(s) 120, computer device(s) 122, the camera(s) 124, and sensor(s) 126 via one more connections, such as networking connections. For example, the video management system 102 may be configured to communicate with the other devices via one or more wired and/or wireless networking connections. In some instances, at least a portion of the system 100 may be implemented as a cloud computing system, and processing may occur offsite by on-demand computing devices. Embodiments are not limited in this manner.

In embodiments, the system 100 including the video management system 102 is configured to receive and process data from the 124 camera(s) and the sensor(s) 126. The video management system 102 may process the data from the camera(s) 124 and sensor(s) 126 and build a live 3D model. In one example, the camera(s) 124 may include a multi-camera sensory units configured to capture image data. The video management system 102 may utilize one or more of the camera feeds from camera(s) 124 to create a 3D map of a space. In some instances, the video management system 102 may be provided with additional details of the space via building blueprints, and 3D models of the space to create a 3D map of physical space. A 3D map can be created with these derivatives, and objects, such as people, may be placed within the 3D map using depth, height, and width coordinates (x, y, and z coordinates).

In embodiments, the image data, which may be real-time image data, may be captured by the camera(s) 124 and processed by video management system 102, for example. Utilizing object detection via image capture devices, such as the camera(s) 124, objects such as people can be tracked using their 3D coordinates (x, y, and z) within the 3D map. An active surveillance scene is monitored by one or more cameras optimally situated to encompass a complete surrounding view of the activities. In some instances, the use of a depth sensor(s) is also possible to recreate a 3D interactive layout of the scene.

In some instances, a secure centralized video processing unit receives and processes (or preprocesses) the live video streams from multiple cameras across the property prior to providing the data to the video management system 102. Each video stream is processed in real-time and passed on to a sequence of image processing algorithms to grab video clips of interest, i.e., having the presence of a person. Video frames are split and individually processed in a multi-layer convolutional neural network to identify frames having people. The original scene image as well as the local processing outputs are encapsulated together and sent to a cloud-based server for further processing. Model normalizer and summarizer module ensure uniformity among people's visual representations. The representations may be one of any of the following: 3D mesh model, skeletal pose, dense cloud of person outline coordinates, 3D bounding box. An optional local identity filtering module detects faces and encodes targeted pixels using either a blurring effect or pixelation effect techniques before transmitting visual data to the video management system 102. In some instances, a secure portion of the video management 102 may perform these operations and embodiments are not limited in this manner.

In embodiments, the video management system 102 may execute a set of advanced vision processing algorithms to break down the individual person detections captured in video frames for further analysis. These include personal attributes that identify and can potentially discriminate visual appearances and identity such as clothing color, gender, skin color, hair color, shoes, and attached personal objects of interest such as bags, scarves, cell phones, hats, etc.

The video management system 102 may include a panoptic segmentation module that identifies clear separation boundaries between closely situated groups of people for accurate localization and mapping. A background prior scene model is computed per camera and provides a rough estimation of the scene topography, dispersion of object occlusions in the scene, and location of entry and exit ways. Camera intrinsic parameters are used to estimate the scene layout and localize the vertical wall planes and a uniform ground plane. The superposition module fuses together the object's 3D world coordinates onto a top-view occupancy grid floor plan. The system may also use 3D mesh generation algorithms to translate the person bounding box onto the 2D scene image.

In embodiments, the system 100 provides constantly updating 3D reproductions in the 3D map such that it can be actively monitored by a security guard, e.g., utilizing remote computing device(s) 118, mobile device(s) 120, and/or computer device(s) 122, enabling the security guard to decipher the occupancy, movement, and activity of people in a physical space. For example, the guard can see whether there is a group of people talking in the lobby of an office building, two individuals fighting at the perimeter, or someone holding a coffee cup while waiting for someone. Non-PIPI information that may be displayed to enable such observations includes the movement of limbs, clothing, and facial movements. At the same time, no PIPI is viewable by the security guard, such as the exact facial features or skin color of the individual. Such features are obscured or reproduced in such a way as to no longer make them identifiable to a particular person or race. If a security incident is about to happen, the security guard may reveal the PIPI of the individual(s) in question if they have permission to do so. If they do not have permission, they may request such permission electronically from an administrator.

Similarly, a user such as a security guard using system 100 may view historic recordings of the 3D reproduction in order to investigate a security incident. In this situation, the guard may view all non-PIPI information about the people's occupancy, movement, and activity, and objects in the physical space. If there is then a need to uncover the PIPI of an individual(s), they may do so, or request to do so, to fulfill the investigation.

In some embodiments, the system 100 may require consent by users. For individuals who occupy and move within physical spaces. They will be able to opt-in to the proactive sharing of their PIPI when they enter a physical space. They may do this through a mobile application, web portal, or physical screen onsite. They may also request that they be notified if their PIPI is ever uncovered for the purposes of preventative or retrospective security, as explained above.

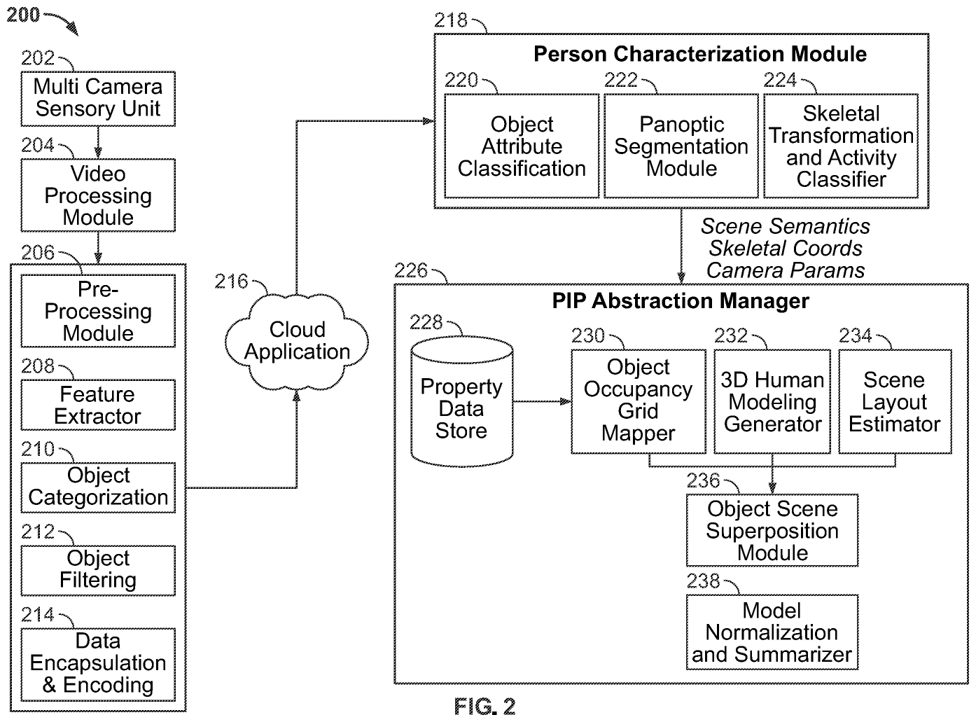

FIG. 2 illustrates an example of a processing flow 200 that may be performed in accordance with embodiments discussed herein. In one example, the processing flow 200 may be performed by system 100. Specifically, the processing flow 200 may include operations performed by system 100 including the video management system 102 to generate a 3D model of a space, detect people in the space, generate representations of the people, and present the 3D model with the representations. In embodiments, system 100 includes using a network of image capture devices, sensors, and processing devices, e.g., camera(s) 124, to generate the 3D reproduction of the presence and movement of people and objects in a physical space. This 3D reproduction ensures that a person can be tracked along with their activity without revealing any PIPI. This non-PIPI 3D reproduction can take the form of a 3D visual model that can be displayed on a screen of a device, such as remote computing device(s) 118, mobile device(s) 120, and computer device(s) 122, for security staff or law enforcement for the purposes of preventative and/or retrospective security.

In block 202, the camera(s) 124, such as a multi-camera sensory unit is configured to capture image data, which may be real-time image or video data. The camera(s) 124 may be configured to capture a space from different angles and image data from each camera(s) 124 may be combined to generate a 3D model of the space using photogrammetric techniques, for example. In some instances, sensor data may be captured by sensor(s) 126 with the real-time image or video data. The sensor data may include depth data and be combined with the image data to generate the 3D model. In embodiments, one or more sensors 126 may be incorporated into the one or more camera(s) 124 including a multi-camera sensory unit.

At block 204, the image data and sensor data may be processed by a video processing module. For example, the system 100, including the server(s) 104 may take multiple images (2D images) from the image data from different cameras and determine points in space (x, y, and z coordinates) for the same object. The server(s) 104 may then align the images relative to the 3D coordinate space to generate a 3D model of the space. In another example, the server(s) 104 may process multiple 3D images from 3D cameras to combine the images to generate a 3D model. The image data and/or sensor data may include depth data such as 3D coordinates of objects within the images, that may be used to align the same objects in different images to align the entire 3D image and create the 3D model. In some instances, a 3D model of a space may be created or pre-created before people are in the space to generate a baseline 3D model of the space. In other instances, a 3D model may be generated in real-time when people are permitted in the space. As discussed in more detail, objects from the image data may be overlaid onto the 3D model pre-created or created in real-time using the determined 3D coordinates for the image data and 3D coordinates of the 3D model space.

At blocks 206 through 214, the system 100 may perform a number of preprocessing, object detection, and data processing techniques prior to providing the processed data to the personal characterization module. For example, at block 206, the system may initialize an object detection analysis to apply to the image data to detect objects and perform pre-processing. For example, a pre-processing module may apply one or more pre-processing algorithms, such as one or more transformation techniques, e.g., Hough transformation, to increase the quality of the image data for further analysis. Other pre-processing techniques may include denoising, e.g., applying a Gaussian or simple box filter, contrast enhancement, down sampling, and morphological operations. Another pre-processing algorithm may include applying a feature selection technique (attribute weighting, dimension reduction, etc.) to filter on the key attributes and/or selecting the attributes. The feature selection techniques may include principal component analysis, information gain, and chi-square, as well as wrapper-type methods like forward selection and backward elimination.

At block 208, the system includes a feature extractor configured to extract features from the image data. The feature extractor is configured to process an initial set of measured data and builds derived values (features) intended to be informative and non-redundant for the image data, facilitating the subsequent learning and generalization steps for the machine-learning model. The repetitiveness of images presented as pixels is transformed into a reduced set of features (also named a feature vector). Determining a subset of the initial features is called feature selection, which may include selecting objects with the space. In some instances, the 3D model without people in it may be used as a baseline, and then the feature extractor may be configured to detect objects in the image data when people are permitted and likely in the space, e.g., the feature extractor selects people as objects (and new objects). The system including the feature extractor, may utilize one or more algorithms including Oriented FAST and Rotated Brief (ORB) algorithm, a color gradient histogram algorithm, a vantage point tree algorithm, a KAZE algorithm, and so forth.

At block 210, the system includes applying an object categorization to the image data. For example, the system may include a classifier configured to classify the image data to determine or classify the object, e.g., determine what the object is. In some instances, the system may utilize a neural network such as CNN to determine objects in the image data. For example, the classifier may determine whether an object is a person or another object, such as a mobile phone. Examples of objects may include people and other items including, but not limited to, mobile devices, bags, cups/mugs, bookbags, umbrellas, or any other object that may be carried or associated with a person. In embodiments, the systems may detect other objects such as pets or animals, vehicles such as scooters, skateboards, etc., and any other type of object.

At block 212, the system may include object filtering. Specifically, the system may identify and filter on the objects that are people and the objects that are not people. In some instances, the system may be configured to apply a multi-object filtering technique, e.g., to track a person and other objects such as a mobile device, mug, bag, etc. Embodiments are not limited in this manner.

At block 214, the system includes applying a data encapsulation and encoding algorithm to the image data. For example, the processed image data may be encapsulated and encoded or encrypted such that it can be communicated to a cloud application at block 216 for further processing. The processed image may be processed in blocks 206-214 by a first server(s) locally and then sent to a cloud application at block 216 for further processing in blocks 218-238 to perform additional processing on objects that are people to generate representations to hide PIPI.

In embodiments, the system includes a person characterization module 218 configured to apply image processing techniques to the objects identified as a person in the image data. At block 220, the system includes applying additional classification techniques to the objects to classify object attribute(s) for the person. For example, the system may apply classification techniques to the person's objects to classify features/attributes of the person, e.g., body parts (arms/legs/torso/head/facial features/etc.). The system may also determine objects associated with the person but not a direct attribute of the person. For example, by applying the classification algorithm, the system may identify the person holding a mug or wearing a backpack.

At block 222, the system includes applying panoptic segmentation techniques to the image data including the objects identified as people. In one example, the panoptic segmentation technique may segment images by semantic segmentation (assign a class label to each pixel) and instance segmentation (detect and segment each object instance).

At block 224, the system includes applying a skeletal transformation and activity classification to objects. For example, the system may apply a morphology algorithm (with or without shape-based pruning), an intersection of boundaries algorithm, curve evolution algorithm, level set algorithm, ridge points on a distance function, etc., to the objects identified as people and other objects that include PIPI. The result may include a skeletal representation of the person.

In embodiments, the system may include an abstraction manager 226 configured to further process the image data including the objects of people and/or associated with the people. For example, at block 230, the system applies an object occupancy grid mapper to the image data. In embodiments, the object occupancy grid mapper may determine 3D coordinates for each of the objects identified in the image data. The 3D coordinates may be in an x, y, and z coordinate format. The grid mapper may identify the 3D coordinates such that the 3D image of the space can be presented on a 2D display.

At block 232, the system may include executing a 3D human model generator on each of the objects identified as people. The 3D human model may convert a personal object into a humanoid format. In one example, the 3D human model generator may utilize a 3D morphing algorithm to convert the personal object into a mesh and then apply a skin layer to the mesh using linear interpolation using both translation and rotation.

At block 234, the system includes applying a scene layout estimator to the image data. For example, the system may include applying one or more scene layout algorithms to the image data to estimate the 3D layout of the space, including the objects. In one example, a deep fully convolutional network may be applied to the image data to generate the 3D layout. Other examples include applying an edge-semantic learning strategy to the image data, a coarse-to-fine indoor layout estimation, layout parameterization, and integral geometry techniques, and so forth.

At block 236, the system may superimpose the objects into the 3D model of the space. For example, the system may include inserting the objects into the 3D model at locations based on the 3D coordinates (x, y, and z) determined for the objects. Moreover, the locations of the objects in the 3D model correspond to locations in real space. At block 238, the system includes applying a model normalization operation and summarizer to the image data. For example, the normalization operation may normalize each of the people objects by removing one or more characteristics or attributes of the people. The characteristics or attributes may include a skin color, a height, a weight (size), a gender, one or more facial features, and so forth. In some embodiments, the normalization operation may include applying a blurring effect or pixilation effect to the personal objects.

In embodiments, the system may summarize or finalize the processed image data to present on a display. As discussed herein, the 3D model with the processed objects may be presented in a display device of a remote computing device, a mobile device, and/or another computer device. Embodiments are not limited in this manner.

In embodiments, the system may perform the operations of the processing flow 200 any number of times. For example, one or more operations performed in the processing flow 200 may be performed periodically to update the 3D model. In an example, the system may first generate a 3D model of the space without people, perform detection operations to detect people, generate representations (processed people objects) of the objects, and present the representations in the 3D model. The system may perform one or more of the operations periodically, e.g., every 0.5 seconds, to update the representations. Thus, the user may be presented with a live real-time video feed of the space as a 3D model with the representations. By first generating the 3D model of the space and then only updating the model with the new objects presented in the space, the system discussed here provides advantages over previous techniques that constantly update the 3D model of the entire space. In the current system, the space without objects can be modeled once and updated infrequently, e.g., every month or so, reducing the amount of processing required to show a live real-time video feed.

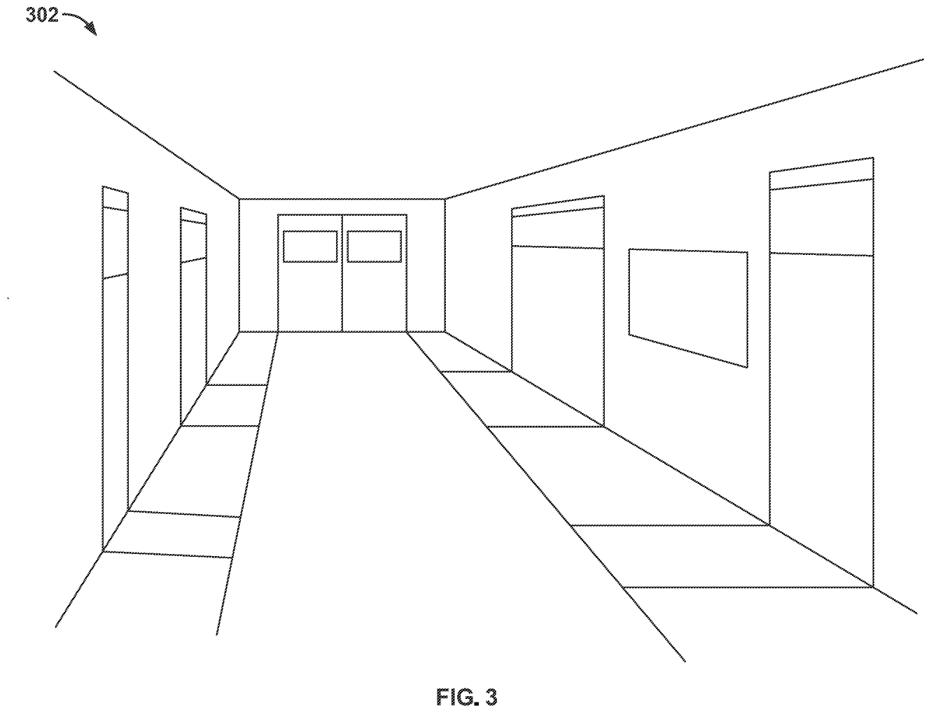

FIGS. 3-5 illustrate an example of a 3D model 302 that may be generated in accordance with embodiments discussed herein. FIG. 3 illustrates an example of the 3D model 302 without any people or other objects in the space. In some embodiments, systems herein may first generate a 3D model of the space without people, and then update the 3D model with people and objects to reduce processing cycles and memory resources, as discussed.

FIG. 3 illustrates one example of a 3D model generated of a hallway space. The 3D model may be generated when no people or moving objects are within the space. In one example, one or more cameras and sensors may be placed within the space and the 3D model may be generated based on the images collected by the cameras and the sensors. In embodiments, the cameras and sensors may ‘locate’ various objects within the space. For example, the system 100 may be configured to determine the x, y, z coordinates of static objects within the space, such as doorways, windows, pictures, etc. These x, y, z coordinates may be from a 0, 0, 0 location, such as where the images were collected from or the location of another camera, such as a surveillance camera's location. This information may then be used to determine the characteristics of the object and place the object within the 3D model.

In real-time, the system 100 may collect images from one or more cameras, sensors, or a combination of and overlay any moving objects and objects not in the original 3D model on the 3D model previously generated. As previously discussed, the system 100 may utilize object detection to detect the objects and spatial algorithms to identify the objects within the space relative to other objects in the space including statics objects in the original 3D model. The system 100 may use this data to place the newly detected objects within the 3D model.

In some instances, the cameras and sensors used to generate the 3D model may be the same cameras and sensors to provide real-time data. However, in other instances, specialized cameras may be used to collect the images and generate the 3D model, and general surveillance cameras may be used to capture the real-time data.

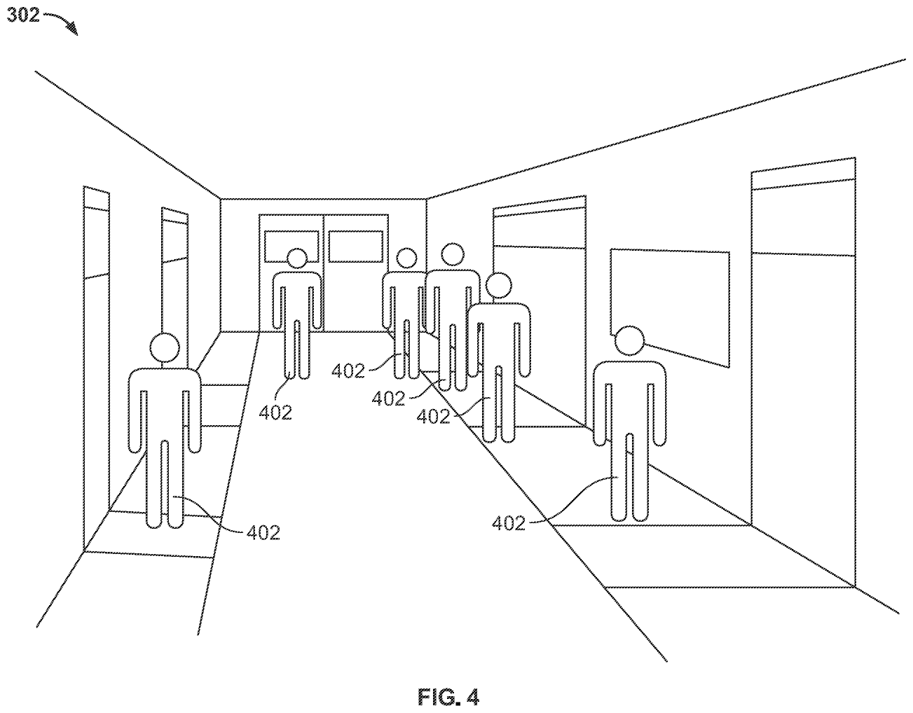

FIG. 4 illustrates an example of the 3D model 302 with object(s) 402 (people) in the space. In the illustrated example, the people are presented with PIPI prior to applying one or more algorithms to hide or obscure the PIPI. The people may be presented in the 3D model 302 in locations corresponding to locations within the real space.

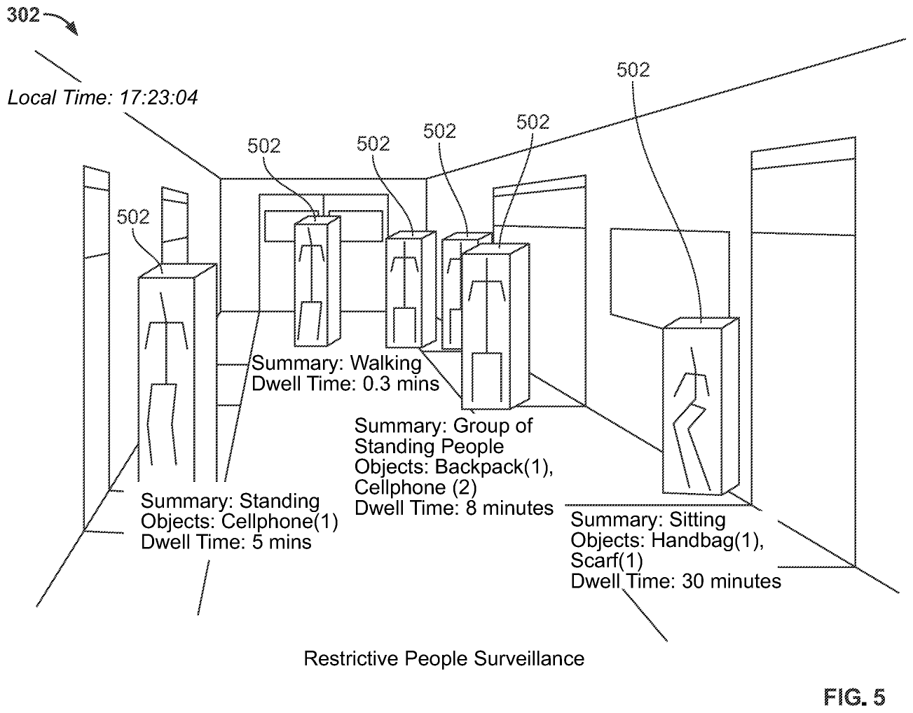

In some instances, the images including the people may be collected by one or more cameras and sensors, and the system 100 may overlay and/or place the objects 402 within the previously generated 3D model based locations determined by the system 100. For example, the system 100 may use the images and sensor date to determine a relative location within the space from a central location (0, 0, 0), which may correspond to the location of the camera/sensors collecting the data. In other instances, the system 100 may determine locations of the objects 402 relative to other objects within the space, e.g., the static objects. The 3D model 302 may be updated as real-time additional data is collected to capture the object's 402 movement within the space. In embodiments, the image illustrated in FIG. 4 may only be presented to a user after the people in the space have consented to be identified. Typically, people may be presented to users as illustrated in FIG. 5 nor

FIG. 5 illustrates an example of the 3D model 302 with the objects (people) as representation(s) 502. In the illustrated example, the representation(s) 502 are skeletal representations in a semi-opaque boxes. The representation(s) 502 may be normalized representations as discussed herein where one or more characteristics or attributes removed from the objects. For example, embodiments may include making all of the representations having the same height, ‘color,’ width, etc. In some instances, each representation may be a copy of the same skeletal representation with added movement. In the illustrated example, the skeletal representation may not have a head and/or show facial. Thus, a user may focus on the movements and actions of the people 502 within the 3D model.

In addition, the 3D model 302 include the representation(s) 502 may include a list of other objects detected and associated with the person, e.g., cellphones, backpacks, bags, etc. The representation(s) 502 may also include other information about the people, e.g., how long they have been present in the space, their movements (standing/walking/standing a group/etc.). The data corresponding to the other objects and statistics of the user may be tracked in stored in a storage system until the person has left space and/or for another determined about of time, e.g., 1-week, 6-months, etc.

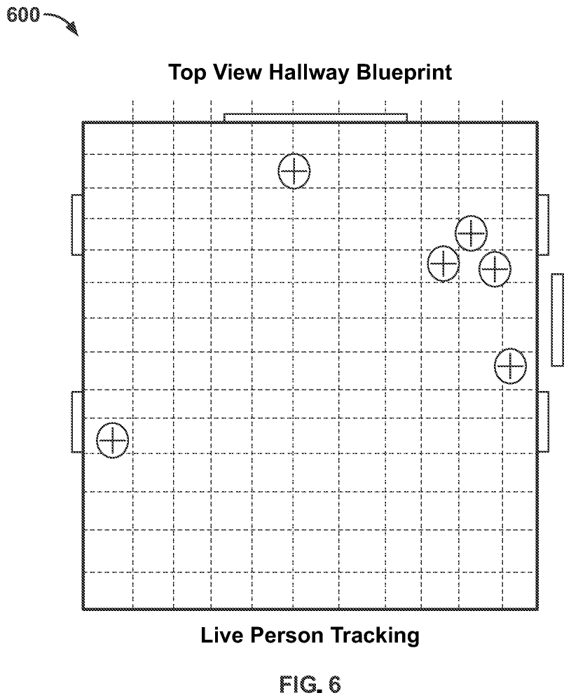

FIG. 6 illustrates an example of a top-down view 600 of the space. The view 600 may be generated from a blueprint of the space, for example. In embodiments, the system may be configured to determine objects in the space and the 3D locations of the objects in the space as discussed herein. The system may also determine 2D coordinate locations of the objects based on the determine 3D locations. The system may then present the objects in the space at their location in the space, as illustrated in FIG. 6. The view 600 may be used by a user to track the movement of objects (people) with a space from a top-down perspective.

FIG. 7 illustrates an embodiment of an exemplary computer architecture 700 suitable for implementing various embodiments as previously described. In one embodiment, the computer architecture 700 may include or be implemented as part of one or more systems or devices discussed herein.

As used in this application, the terms “system” and “component” are intended to refer to a computer-related entity, either hardware, a combination of hardware and software, software, or software in execution, examples of which are provided by the exemplary computing computer architecture 700. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 100 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 100.

As shown in FIG. 7, the computing architecture 100 includes a processor 712, a system memory 704 and a system bus 706. The processor 712 can be any of various commercially available processors.

The system bus 706 provides an interface for system components including, but not limited to, the system memory 704 to the processor 712. The system bus 706 can be any of several types of bus structure that may further interconnect to a memory bus (with or without a memory controller), a peripheral bus, and a local bus using any of a variety of commercially available bus architectures. Interface adapters may connect to the system bus 608 via slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 100 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 704 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 7, the system memory 704 can include non-volatile 708 and/or volatile 710. A basic input/output system (BIOS) can be stored in the non-volatile 708.

The computer 702 may include various types of computer-readable storage media in the form of one or more lower speed memory units, including an internal (or external) hard disk drive 730, a magnetic disk drive 716 to read from or write to a removable magnetic disk 720, and an optical disk drive 728 to read from or write to a removable optical disk 732 (e.g., a CD-ROM or DVD). The hard disk drive 730, magnetic disk drive 716 and optical disk drive 728 can be connected to system bus 706 the by an HDD interface 714, and FDD interface 718 and an optical disk drive interface 734, respectively. The HDD interface 714 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and non-volatile 708, and volatile 710, including an operating system 722, one or more applications 742, other program modules 724, and program data 726. In one embodiment, the one or more applications 742, other program modules 724, and program data 726 can include, for example, the various applications and/or components of the systems discussed herein.

A user can enter commands and information into the computer 702 through one or more wire/wireless input devices, for example, a keyboard 750 and a pointing device, such as a mouse 752. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, track pads, sensors, styluses, and the like. These and other input devices are often connected to the processor 712 through an input device interface 736 that is coupled to the system bus 706 but can be connected by other interfaces such as a parallel port, IEEE 1394 serial port, a game port, a USB port, an IR interface, and so forth.

A monitor 744 or other type of display device is also connected to the system bus 706 via an interface, such as a video adapter 746. The monitor 744 may be internal or external to the computer 702. In addition to the monitor 744, a computer typically includes other peripheral output devices, such as speakers, printers, and so forth.

The computer 702 may operate in a networked environment using logical connections via wire and/or wireless communications to one or more remote computers, such as a remote computer(s) 748. The remote computer(s) 748 can be a workstation, a server computer, a router, a personal computer, portable computer, microprocessor-based entertainment appliance, a peer device or other common network node, and typically includes many or all the elements described relative to the computer 702, although, for purposes of brevity, only a memory and/or storage device 758 is illustrated. The logical connections depicted include wire/wireless connectivity to a local area network 756 and/or larger networks, for example, a wide area network 754. Such LAN and WAN networking environments are commonplace in offices and companies, and facilitate enterprise-wide computer networks, such as intranets, all of which may connect to a global communications network, for example, the Internet.

When used in a local area network 756 networking environment, the computer 702 is connected to the local area network 756 through a wire and/or wireless communication network interface or network adapter 738. The network adapter 738 can facilitate wire and/or wireless communications to the local area network 756, which may also include a wireless access point disposed thereon for communicating with the wireless functionality of the network adapter 738.

When used in a wide area network 754 networking environment, the computer 702 can include a modem 740, or is connected to a communications server on the wide area network 754 or has other means for establishing communications over the wide area network 754, such as by way of the Internet. The modem 740, which can be internal or external and a wire and/or wireless device, connects to the system bus 706 via the input device interface 736. In a networked environment, program modules depicted relative to the computer 702, or portions thereof, can be stored in the remote memory and/or storage device 758. It will be appreciated that the network connections shown are exemplary and other means of establishing a communications link between the computers can be used.

The computer 702 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11 (a, b, g, n, etc.) to provide secure, reliable, fast wireless connectivity. A Wi-Fi network can be used to connect computers to each other, to the Internet, and to wire networks (which use IEEE 802.3-related media and functions).

The various elements of the devices as previously described herein may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

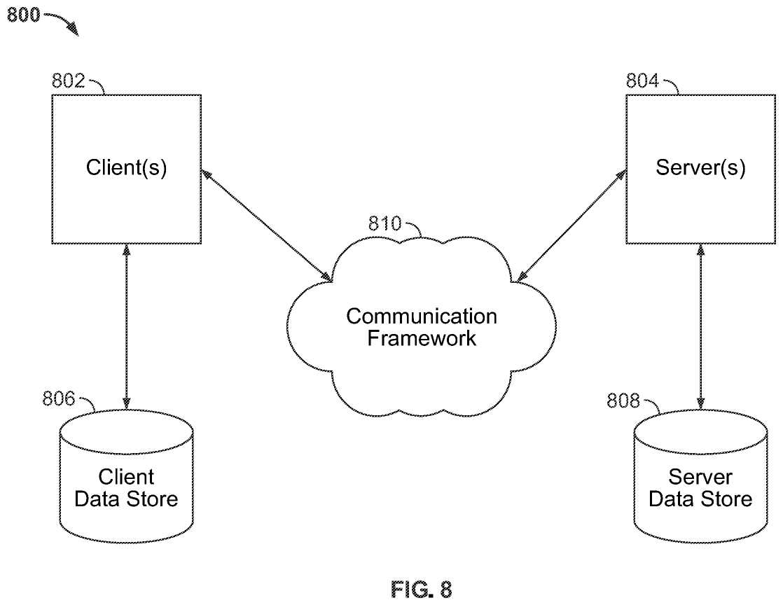

FIG. 8 is a block diagram depicting an exemplary communications architecture 800 suitable for implementing various embodiments as previously described. The communications architecture 800 includes various common communications elements, such as a transmitter, receiver, transceiver, radio, network interface, baseband processor, antenna, amplifiers, filters, power supplies, and so forth. The embodiments, however, are not limited to implementation by the communications architecture 800, which may be consistent with systems and devices discussed herein.

As shown in FIG. 8, the communications architecture 800 includes one or more client(s) 802 and server(s) 804. The server(s) 804 may implement one or more functions and embodiments discussed herein. The client(s) 802 and the server(s) 804 are operatively connected to one or more respective client data store 806 and server data store 808 that can be employed to store information local to the respective client(s) 802 and server(s) 804, such as cookies and/or associated contextual information.

The client(s) 802 and the server(s) 804 may communicate information between each other using a communication framework 810. The communication framework 810 may implement any well-known communications techniques and protocols. The communication framework 810 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communication framework 810 may implement various network interfaces arranged to accept, communicate, and connect to a communications network. A network interface may be regarded as a specialized form of an input/output (I/O) interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.7a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by client(s) 802 and the server(s) 804. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

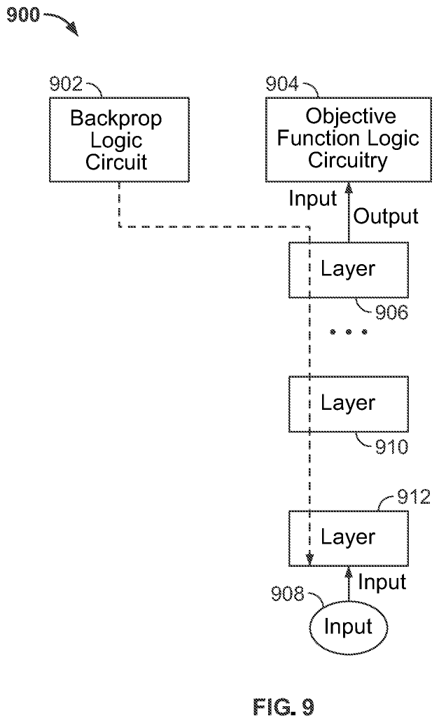

FIG. 9 depicts an embodiment of a neural network (NN) 900 that may be applied to image data (video frames) to perform operations discussed herein. The NN 900 may comprise as a deep neural network (DNN) such as a convolutional neural network (CNN).

A DNN is a class of artificial neural network with a cascade of multiple layers that use the output from the previous layer as input. An example of a DNN is a recurrent neural network (RNN) where connections between nodes form a directed graph along a sequence. A feedforward neural network is a neural network in which the output of each layer is the input of a subsequent layer in the neural network rather than having a recursive loop at each layer.

Another example of a DNN is the CNN. A CNN is a class of deep, feed-forward artificial neural networks. A CNN may comprise of an input layer and an output layer, as well as multiple hidden layers. The hidden layers of a CNN typically consist of convolutional layers, pooling layers, fully connected layers, and normalization layers.

The NN 900 comprises an input layer 908, and three or more layers 912 and 910 through 906, which may be used to process the image data. The input layer 908 may comprise input data that is training data for the NN 900 or at least part of a communication for which the NN 900, in inference mode, will objects in the image data. The input layer 908 may provide the data in the form of tensor data to the layer 912. The tensor data may include a vector, matrix, or the like with values associated with each input feature of the NN 900.

The image data may comprise various types of information related to objects within spaces. The information may include, e.g., historical information associated with a particular space and characteristics of people.

In many embodiments, the input layer 908 is not modified by backpropagation. The layer 912 may compute an output and pass the output to the layer 910. Layer 910 may determine an output based on the input from layer 912 and pass the output to the next layer and so on until the layer 906 receives the output of the second to last layer in the NN 900. Depending on the methodology of the NN 900, each layer may include input functions, activation functions, and/or other functions as well as weights and biases assigned to each of the input features. The weights and biases may be randomly selected or defined for the initial state of a new model and may be adjusted through training via backwards propagation (also referred to as backpropagation or backprop). When retraining a model with customer data obtained after an initial training of the model, the weights and biases may have values related to the previous training and may be adjusted through retraining via backwards propagation.

The layer 906 may generate an output, such as an indication of object including whether the object is a person or not, and pass the output to an objective function logic circuitry 904. The objective function logic circuitry 904 may determine errors in the output from the layer 906 based on an objective function such as a comparison of the predicted results against the expected results. For instance, the expected results may be paired with the input in the training data supplied for the NN 900 for supervised training.

During the training mode, the objective function logic circuitry 904 may output errors to backpropagation logic circuitry 902 to backpropagate the errors through the NN 900. For instance, the objective function logic circuitry 904 may output the errors in the form of a gradient of the objective function with respect to the input features of the NN 900.

The backpropagation logic circuitry 902 may propagate the gradient of the objective function from the top-most layer, layer 906, to the bottom-most layer, layer 912 using the chain rule. The chain rule is a formula for computing the derivative of the composition of two or more functions. That is, if f and g are functions, then the chain rule expresses the derivative of their composition fºg (the function which maps x to f(g(x))) in terms of the derivatives of f and g. After the objective function logic circuitry 904 computes the errors, backpropagation logic circuitry 902 backpropagates the errors. The backpropagation is illustrated with the dashed arrows.

What is claimed is:

1. A computer-implemented method, comprising:
receiving, by a system, data corresponding to a space of a building, the data comprising at least one or more images of the space;
generating, by the system, a three-dimensional (3D) model of the space;
receiving, by the system, real-time data from one or more cameras capturing at least images of the space, the real-time data comprising at least one image of the images including a person within the space;
generating, by the system, a normalized representation of the person, the normalized representation configured to obscure personally identifiable physical information associated with the person;
determining, by the system, a location of the person within the space;
overlaying, by the system, the normalized representation of the person in the 3D model at the location; and
providing, by the system, the 3D model overlaid with the normalized representation to display.

2. The computer implemented method of claim 1, wherein the data is captured by a first camera, and the real-time data is captured by a second camera, and the first camera and the second camera a different cameras.

3. The computer implemented method of claim 1, wherein the data is captured with one or more cameras comprising one or more of a 2 dimensional (2D) image sensor, a 3D image sensor, a depth sensor, or any combination thereof, and is configured to capture the space in 3D.

4. The computer implemented method of claim 1, comprising applying an object detection analysis on the real-time data to identify the person, the object detection analysis comprising one or more of performing pre-processing operations, performing feature extracting operations, object categorization operations, perform object filtering operations, or any combination thereof.

5. The computer implemented method of claim 1, comprising applying a classification technique to the real-time data to identify and classify objects and attributes associated with the person.

6. The computer implemented method of claim 5, overlaying a description of the objects and attributes on the 3D model with the associated person.

7. The computer implemented method of claim 1, comprising applying a skeletal transformation to the real-time data including the image of the person to generate the normalized representation.

8. The computer implemented method of claim 1, comprising applying a model normalization operation and summarizer to the real-time data to remove one or more objects or attributes associated with the person.

9. The computer implemented method of claim 8, wherein the attributes associated with the person comprise a skin color, a height, a weight (size), a gender, and one or more facial features.

10. The computer implemented method of claim 1, wherein generating the normalized representation comprises applying a blurring effect, a pixilation effect, or both to the person, one or more associated objects, or both.

11. A computing apparatus comprising:
a processor; and
a memory storing instructions that, when executed by the processor, configure the processor to:
process data corresponding to a space of a building received from one or more cameras, the data comprising at least one or more images of the space;
generate a three-dimensional (3D) model of the space;
process real-time data from the one or more cameras capturing images of the space, the real-time data comprising at least one image of the images including a person within the space;
generate a normalized representation of the person, the normalized representation configured to obscure personally identifiable physical information associated with the person;
determine a location of the person within the space;
overlay the normalized representation of the person in the 3D model at the location; and
provide the 3D model overlaid with the normalized representation to display.

12. The computing apparatus of claim 11, wherein the one or more cameras comprise one or more of a 2 dimensional (2D) image sensor, a 3D image sensor, a depth sensor, or any combination thereof, and is configured to capture the space in 3D.

13. The computing apparatus of claim 11, comprising instructions configured to cause the processor to apply an object detection analysis on the real-time data to identify the person, the object detection analysis comprising one or more of performing pre-processing operations, performing feature extracting operations, object categorization operations, perform object filtering operations, or any combination thereof.

14. The computing apparatus of claim 11, comprising instructions configured to cause the processor to apply a classification technique to the real-time data to identify and classify objects and attributes associated with the person.

15. The computing apparatus of claim 14, comprising instructions configured to cause the processor to overlay a description of the objects and attributes on the 3D model with the associated person.

16. The computing apparatus of claim 11, comprising instructions configured to cause the processor to apply a skeletal transformation to the real-time data including the image of the person to generate the normalized representation.

17. The computing apparatus of claim 11, comprising instructions configured to cause the processor to apply a model normalization operation and summarizer to the real-time data to remove one or more objects or attributes associated with the person.

18. The computing apparatus of claim 17, wherein the attributes associated with the person comprise a skin color, a height, a weight (size), a gender, and one or more facial features.

19. The computing apparatus of claim 11, wherein generating the normalized representation comprises apply a blurring effect, a pixilation effect, or both to the person, one or more associated objects, or both.

20. A non-transitory computer-readable storage medium, the computer-readable storage medium including instructions that when executed by a system, cause the system to:
receive data corresponding to a space of a building, the data comprising at least one or more images of the space;
generate a three-dimensional (3D) model of the space;
receive real-time data from one or more cameras capturing at least images of the space, the real-time data comprising at least one image of the images including a person within the space;
generate a normalized representation of the person, the normalized representation configured to obscure personally identifiable physical information associated with the person;
determine a location of the person within the space;
overlay the normalized representation of the person in the 3D model at the location; and
provide the 3D model overlaid with the normalized representation to display.
